(19) United States
(12) Patent Application Publication
(10) Pub. No.: US 2004/0246943 A1
(43) Pub. Date: Dec. 9, 2004

(54) Connection of link sets to switching centers

(76) Inventor: Manfred Angermayr, Schrobenhausen (DE)

Correspondence Address: Siemens Corporation, Intellectual Property Department, 170 Wood Avenue South, Iselin, NJ, 08830, US

(21) Appl. No.: 10/491,973

(22) PCT Filed: Sep. 12, 2002
(86) PCT No.: PCT/DE02/03402

(30) Foreign Application Priority Data
Oct. 5, 2001 (DE) 101492979

(51) Int. Cl. H04L 12/66

(52) U.S. Cl. 370/352; 370/389; 370/465

(57) ABSTRACT

The present invention relates to an arrangement and a method for connecting several link sets to a switching center in a telecommunication network. According to said invention, messages are transmitted and received with different destination and originating point codes in several link sets. The destination point codes of the received messages are converted into the destination point code of the switching center and the originating point code of the messages, which are transmitted by said switching center, by means of a table, which contains originating point codes corresponding to the destination point codes of the messages transmitted by the switching center.

### CROSS REFERENCE TO RELATED APPLICATIONS

This application is the US National Stage of International Application No. PCT/DE02/03402, filed Sep. 12, 2002 and claims the benefit thereof. The International Application claims the benefits of German application No. 10149297.9 filed Oct. 5, 2001, both applications are incorporated by reference herein in their entirety.

### FIELD OF INVENTION

The present invention relates to an arrangement and a method for connecting several link sets to a switching center in a telecommunication network.

### BACKGROUND OF INVENTION

Telecommunication networks consist of a plurality of switching centers (nodes) which can form further individual networks in conjunction with the nodes connected to them. For the purpose of controlling telecommunication networks, information or signaling is transmitted between switching centers in parallel to the actual useful data, and in so doing a distinction is usually made between devices in which signaling is originated or received (signaling end points, SEP) and devices which serve to connect signaling end points (signaling transfer points, STP and signaling links). For the purpose of exchanging messages, signaling link sets (for example with 16 signaling links) are set up between the individual signaling points.

Each signaling point, such as a switching center (node), is uniquely identified in the network by a signaling point code (SPC). The switching centers forward incoming messages with the aid of routing tables in which all possible destination signaling points and the signaling paths to be used have been entered. It is therefore important that any change to the signaling point code (SPC) of a switching center should be notified to all the affected switching centers in the network.

In such a communication network, if a network operator who operates a plurality of networks with their own switching centers wishes to combine certain switching centers or replace them with a new switching center, then virtually all affected switching centers must change their link sets from the old switching centers to the new switching center, since the new switching center is not permitted to have a plurality of signaling point codes. This requires operators to reach agreements with one another.

In order to operate a plurality of link sets on a “primary” point code it is known for a plurality of internal networks to be set up on a single node and linked together by means of connection loops so that from the outside they are recognizable only as a single network with a plurality of “primary” point codes. A specific link set can be connected to each of these internal networks. However, the disadvantage of this is that the number of internal networks that can be set up is usually strictly limited. For adequate interaction or for installing the connection loops between the individual internal networks additional modules are required and the necessary network transitions increase the transfer time.

### SUMMARY OF INVENTION

The object of the invention consists in specifying an arrangement or method whereby it will be possible to avoid having to rearrange switching centers that are affected when switching centers are combined within the network.

This object is achieved by means of the features which will emerge from the individual claims. According to these, messages are transmitted and received by the switching center with different destination and originating point codes in individual link sets. The destination point codes of the received messages are converted into the destination point codes of the switching center and the originating point codes of the messages transmitted by the said switching center, by means of a table which contains originating point codes corresponding to the destination point codes of the messages transmitted by the switching center. This removes the need to make changes to the signaling environment when two switching centers are combined into one. The new switching center requires no special adaptation. The conversion can be carried out in the switching center itself or remotely.

If the arrangement or method to which the present invention relates is also used in a partner switching center, a plurality of parallel link sets can be operated so as to increase the bandwidth between two switching centers without additional network transitions.

Further features and advantages of the invention will emerge from the dependent claims.

### BRIEF DESCRIPTION OF THE DRAWING

The present invention is further explained by reference to the accompanying drawings, which show the following:

FIGS. 1a and 1b—an example of the method to which the invention relates when two switching centers are combined,

FIG. 2—an example of the arrangement to which the invention relates for increasing the bandwidth of the connection between two switching centers,

FIG. 3—a further example of the arrangement to which the invention relates for increasing the bandwidth of the connection between two switching centers,

FIG. 4—an example of the method to which the invention relates in which the conversion is remote from the switching center and

FIG. 5—the data link according to the example shown in FIG. 4.

### DETAILED DESCRIPTION OF INVENTION

The present invention is further explained using the example of Signaling System No 7 (SS7), which provides modalities and information for harmonizing the signaling between network nodes (switching centers) and is increasingly used in telecommunication networks.

The basic architecture of Signaling System 7 forms the message transfer part (MTP). This establishes a connection between two adjacent signaling points and provides failsafe transmission of control information between them. Different user parts are superimposed on the message transfer part, and these establish virtual “end-to-end” connections between the originating switching center and the destination switching center.

In Signaling System 7, each signaling point, such as a node, is uniquely identified by a 14-bit signaling point code. Each message contains the signaling point code of both the originating point code (OPC) and the destination point code (DPC). According to the standards of the ITU-T (International Telecommunication Union) and ANSI (American National Standards Institute), it is not possible to operate two SS7 nodes (switching centers) with the same signaling point code in one and the same MTP network.

However, a “primary” point code and a plurality of “secondary” point codes can be assigned to a single node, though a “secondary” point code receives only minimal support from the message transfer part MTP (Level 3) and unlike the “primary” point code, no link sets can be connected to it.

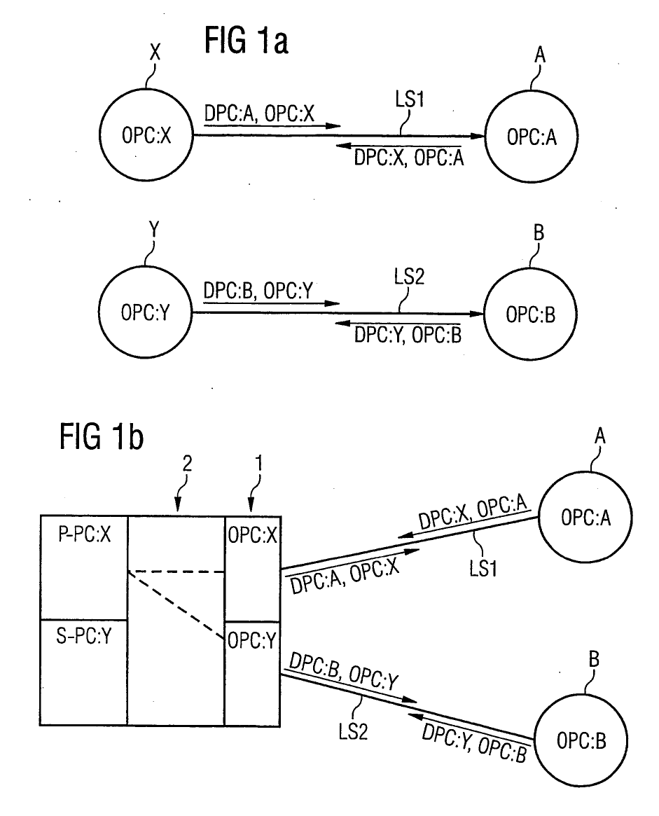

FIG. 1 shows the signaling for four typical switching centers A, B, X, Y. A link set LS1 is set up from the switching center X with the originating point code OPC:X to the switching center A with the originating point code OPC:A and a link set LS2 is set up from the switching center Y with the originating point code OPC:Y to the switching center B with the originating point code OPC:B. Messages sent from the switching center X to the switching center A then contain the destination point code DPC:A and the originating point code OPC:X. Similarly, messages sent from the switching center A to the switching center X contain the destination point code DPC:X and the originating point code OPC:A.

If the two switching centers X and Y were then to be combined in the switching center X, a new link set would have to be established from the switching center B to the switching center X and the destination point code DPC:Y of the messages sent from the switching center B would have to be changed into the destination point code DPC:X.

FIG. 1b shows a typical solution according to the present invention. As can be seen, the originating and destination point codes of the messages sent and received at the switching centers A and B have not changed. The messages received by the sending and receiving unit 1 of the switching center A via the link set LS1 are forwarded unchanged to the switching center X, since the originating and/or destination point code of the switching center X has been retained. In the case of messages received by the switching center B via the link set LS2, the destination point code DPC:Y is replaced in the conversion unit 2 by the destination point code DPC:X of the switching center X. In the same way, messages from the switching center X for transmission to the switching center A are sent unchanged by the sending and receiving unit 1 to the switching center A via the link set LS1, and the originating point code OPC:X in messages sent to the switching center B via the link set LS2 are replaced by the originating point code OPC:Y.

If a plurality of switching centers are coupled to the sending and receiving unit 1, the originating point code OPC:X of the switching center X is converted by means of a table which contains the appropriate originating point code OPC:X, OPC:Y corresponding to the respective destination point codes DPC:A, DPC:B of the messages sent from the switching center X. To messages which are sent from the switching center X to the switching centers A and B, the table allocates the appropriate link set LS1, LS2 and the appropriate originating point code OPC:X, OPC:Y corresponding to the individual link sets LS1, LS2.

Although the link sets LS1 and LS2 are coupled to the primary signaling point code P-PC:X, the switching center X appears to be connected to the arrangement to which the invention relates in the network as a switching center in which link set LS1 is coupled to the primary signaling point code PPC:X and link set LS2 is coupled to the secondary signaling point code S-PC:Y.

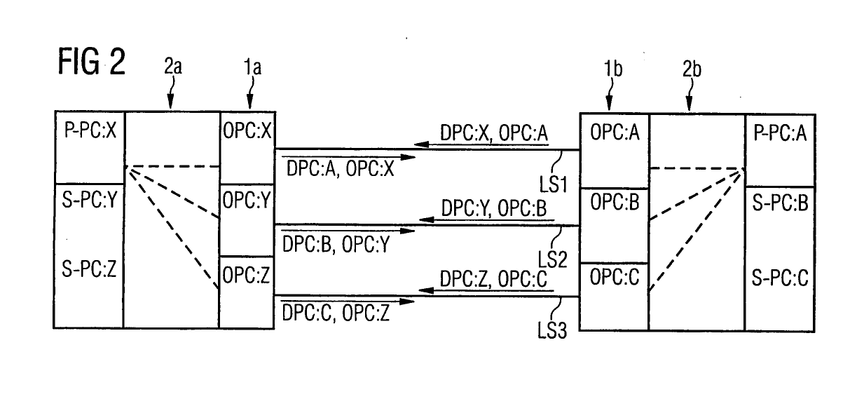

If the arrangement to which the invention relates as shown in FIG. 2 is used in two adjacent MTP nodes, a plurality of link sets LS1, LS2, LS3 can be set up between two nodes. Conversion of the signaling point codes as shown in FIG. 1b then takes place in both MTP nodes.

In this case, allocation of the originating and destination point codes DPC:A, DPC:B, DPC:C and OPC:X, OPC:Y, OPC:Z and also of the link sets LS1, LS2, LS3 to messages that are to be transmitted to the sending and receiving unit 1b can be carried out automatically in the conversion unit 2a. Thus for example, originating and destination point codes DPC:A, OPC:X-DPC:B, OPC:Y-DPC:C, OPC:Z, and so on, are allocated consecutively to messages that are to be sent. It is however possible, as in the example shown in FIG. 1b, that the message to be sent is already allocated to one of the (in this example three) destination point codes DPC:A, DPC:B, DPC:C. In both cases though, originating point codes OPC:X, OPC:Y, OPC:Z are converted in the conversion unit 2b.

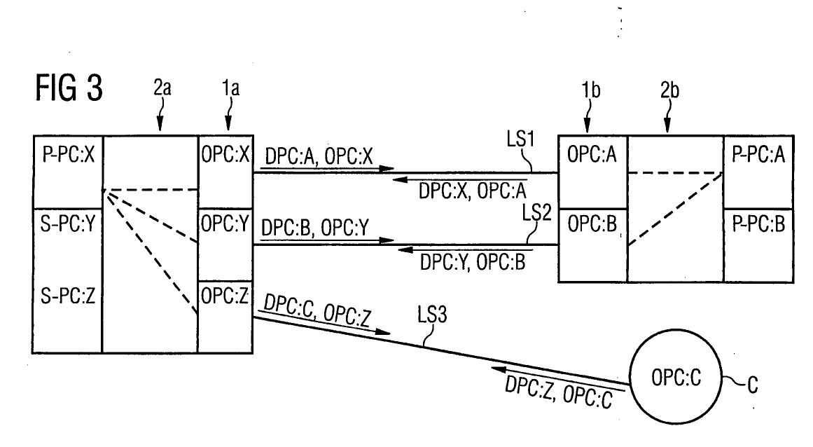

The examples shown in FIG. 1b and FIG. 2 can also be combined as shown in FIG. 3, since the conversion unit 2a allocates the appropriate originating and destination point codes DPC:A, OPC:X-DPC:B, OPC:Y-DPC:C, OPC:Z to each message.

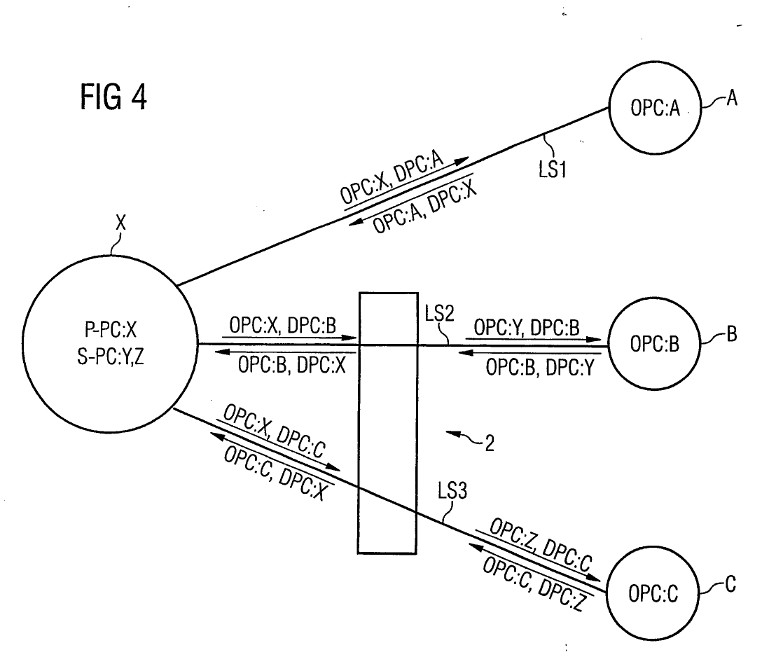

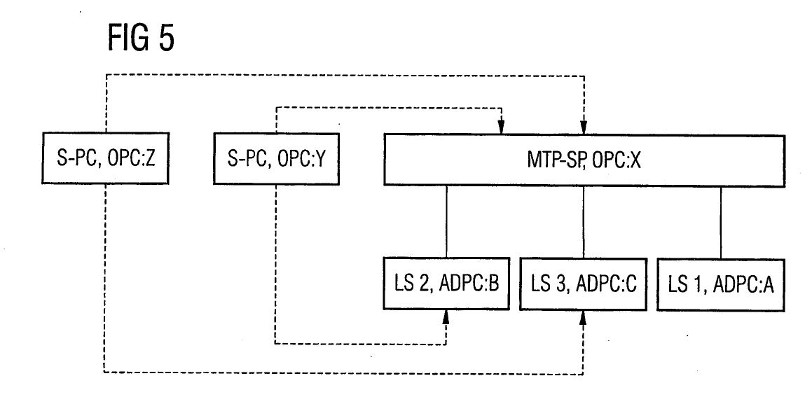

FIG. 4 shows an example in which the conversion of the switching center X is carried out remotely in an external conversion unit 2 (switch). The link sets LS1, LS2 and LS3 from the switching center X to the switching centers A, B and C are allocated to the signaling point code OPC:X. Due to the conversion in the conversion unit 2 it appears as if the link sets LS2, LS3 are connected to the secondary point codes S-PC:Y, S-PC:Z. A conversion between the switching center X and the switching center A is not necessary, since the link set LS1 to the switching center A is coupled to the primary point code P-PC:X. FIG. 5 shows the corresponding data linking. The central data object is the MTP signaling point MTP-SP, that is, the MTP network with the primary signaling point code OPC:X. Each link set LS1, LS2, LS3 is, since it is allocated uniquely to a specific MTP network, identified by its adjacent node ADPC:A, ADPC:B, ADPC:C (indicated by the solid lines). In parallel to the primary signaling point code OPC:X, the secondary signaling point codes S-PC OPC:Y; S-PC OPC:Z are also set up and allocated to the primary signaling point code OPC:X (indicated by the dotted lines). So that a conversion of the corresponding destination and originating point codes DPC, OPC can be carried out, the secondary signaling point codes OPC:Y, OPC:Z must be allocated to the corresponding link sets LS2, LS3 (indicated by the dotted broken lines).

1.-5. (canceled).

6. An arrangement for connecting several link sets to a switching center in a telecommunication network, comprising:
a sending and receiving unit for sending and receiving messages on the multiple link sets, in which arrangement the destination and originating point codes of the sent and received messages in the individual link sets are different; and
a conversion unit which converts the destination point codes of the messages received by the sending and receiving unit into the destination point code of the switching center and the originating point code of the messages sent by the switching center by a table containing originating point codes corresponding to the destination point codes of the messages transmitted by the switching center.

7. An arrangement according to claim 6, wherein the arrangement is integrated into the switching center.

8. An arrangement according to claim 6, wherein at least one part of the multiple link sets leads to a second switching center which can be addressed with the aid of a plurality of destination point codes.

9. A method for connecting several link sets to a switching center in a telecommunication network, comprising:
transmitting and receiving messages with different destination and originating point codes in several link sets; and
converting the destination point codes of the received messages into the destination point code of the switching center and the originating point code of the messages which are transmitted by said switching center, by a table containing originating point codes corresponding to the destination point codes of the messages transmitted by the switching center.

10. A method according to claim 4, wherein messages with at least one part of the multiple link sets are sent to a second switching center which can be addressed with the aid of a plurality of destination point codes and are received by the second switching center.

11. An arrangement according to claim 7, wherein at least one part of the multiple link sets leads to a second switching center which can be addressed with the aid of a plurality of destination point codes.
